(19) United States
(12) Patent Application Publication
(10) Pub. No.: US 2015/0242460 A1
(43) Pub. Date: Aug. 27, 2015

(54) RECOMMENDING COLLABORATORS BASED ON USERS' CONTENT COLLECTIONS

(71) Applicant: Vikas KRISHNA, San Jose, CA (US)

(72) Inventor: Vikas KRISHNA, San Jose, CA (US)

(73) Assignee: CA, INC., Islandia, NY (US)

(21) Appl. No.: 14/225,714

(22) Filed: Mar. 26, 2014

Related U.S. Application Data
(60) Provisional application No. 61/943,842, filed on Feb. 24, 2014.

(51) Int. Cl. G06F 17/30; H04L 29/08

(52) U.S. Cl. CPC G06F 17/30424; H04L 67/10

(57) ABSTRACT

A method may include receiving a selected document, or a set of documents, from a user, analyzing a content of the selected document, or documents, and determining a category of skill based on the content of the selected document. The method may also include locating a plurality of collaborators by matching the category of skill with a corresponding category of skill of a potential collaborator selected from a plurality of potential collaborators, and ranking the plurality of collaborators based on a predetermined score for the corresponding category of skill. Further, the method may include presenting the user with a ranked list of the plurality of collaborators based on the ranking of the plurality of collaborators.

### BACKGROUND

The disclosure relates generally to recommending collaborators for a user, and more specifically, to a system and method for providing collaborators based on requisite skills determined from the user's selected documents and the potential collaborator's content collections.

### SUMMARY

According to one embodiment of the disclosure, a method may include receiving a selected document, or documents, from a user, and analyzing the content of the selected document or documents. The method may also include determining a category of skill, or categories of skills, based on the content of the selected document, and locating a plurality of collaborators by matching the categories of skills with corresponding categories of skills of collaborators. The method may include ranking the plurality of collaborators on the corresponding category of skill, and presenting the user with a ranked list of the plurality of collaborators based on the ranking of the plurality of collaborators.

Other features and advantages of the present disclosure are apparent to persons of ordinary skill in the art in view of the following detailed description of the disclosure and the accompanying drawings.

### BRIEF DESCRIPTION OF THE DRAWINGS

For a more complete understanding of the configurations of the present disclosure, needs satisfied thereby, and the features and advantages thereof, reference now is made to the following description taken in connection with the accompanying drawings.

FIG. 1 illustrates a block diagram of a network for a user to access a collaborator recommendation module, in accordance with a particular embodiment of the present disclosure.

FIG. 2 illustrates a block diagram of a system for recommending collaborators based on the collaborator's content collections, in accordance with a particular embodiment of the present disclosure.

FIG. 3 illustrates a flow chart of a method for categorizing a collaborator's content collections, in accordance with a particular embodiment of the present disclosure.

FIG. 4 illustrates a flow chart for a method for selecting a list of potential collaborators, in accordance with a particular embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language, such as JAVA®, SCALA®, SMALLTALK®, EIFFEL®, JADED, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

While certain example systems and methods disclosed herein may be described with reference to mainframes in cloud computing, systems and methods disclosed herein may be related to architecture and information technology (“IT”) service and asset management in cloud computing, as well as usability and user experience in middleware and common services. Systems and methods disclosed herein may be applicable to a broad range of applications that monitor various parameters associated with various disciplines, such as, for example, IT systems and other activities of importance to the user.

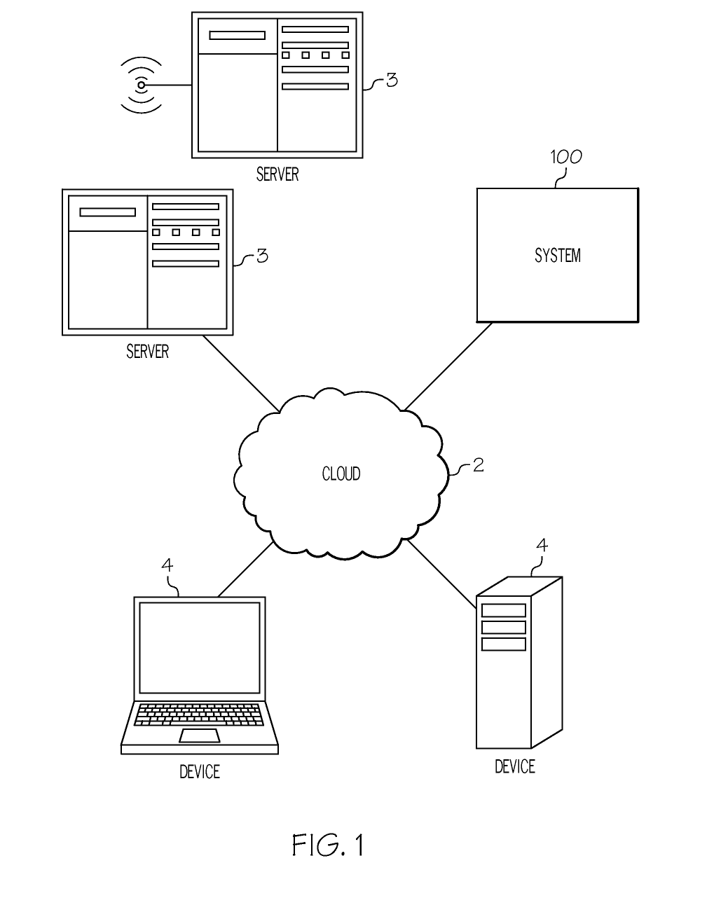

Referring now to FIG. 1, a network 1 allows a user to access and use a content management module for cloud-based services. The cloud-based services may be internally provided or sourced through third parties. Network 1 may comprise one or more clouds 2, which may be public clouds, private clouds, or community clouds. Each cloud 2 may permit the exchange of information and services among users that are connected to such clouds 2. In certain configurations, cloud 2 may be a wide area network, such as the Internet. In some configurations, cloud 2 may be a local area network, such as an intranet. Further, cloud 2 may be a closed, private network in certain configurations, and cloud 2 may be an open network in other configurations. Cloud 2 may facilitate wired or wireless communications of information among users that are connected to could 2.

Network 1 may comprise one or more servers 3 and other devices operated by service providers and users. Network 1 also may comprise one or more devices 4 utilized by users. Service providers and users may provide information to each other utilizing the one or more servers 3, which connect to the one or more devices 4 via cloud 2. Servers 3 may comprise, for example, one or more of general purpose computing devices, specialized computing devices, mainframe devices, wired devices, wireless devices, monitoring devices, infrastructure devices, and other devices configured to provide information to service providers and users. Devices 4 may comprise, for example, one or more of general purpose computing devices, specialized computing devices, mobile devices, wired devices, wireless devices, passive devices, routers, switches, mainframe devices, monitoring devices, infrastructure devices, and other devices utilized by service providers and users. Example items may include network 1, cloud 2, servers 3, and devices 4.

Moreover, network 1 may comprise one or more systems 100 that may provide a collaborator recommendation module. System 100 may be, for example, one or more of a general purpose computing device, a specialized computing device, a wired device, a wireless device, a mainframe device, an infrastructure device, a monitoring device, and any other device configured to provide a service reservation module. System 100 may also be configured to collect data from one or more data sources (e.g., servers, sensors, networks, interfaces, other devices). System 100 may collect information from network 1, cloud 2, servers 3, devices 4, and other devices connected to cloud 2. System 100 may connect to cloud 2 and monitor network 1, cloud 2, servers 3, devices 4, and other devices connected to cloud 2 for available information. The available information may be user information, document content information, categories of skills information, and other information provided by service providers and users. By collecting the available information from network 1, cloud 2, servers 3, devices 4, and other devices connected to cloud 2, system 100 may perform one or more tasks associated with using the collaborator recommendation module, which is discussed in more detail below. In some configurations, one or more of servers 3 and devices 4 may comprise system 100. In other configurations, system 100 may be separate from servers 3 and devices 4.

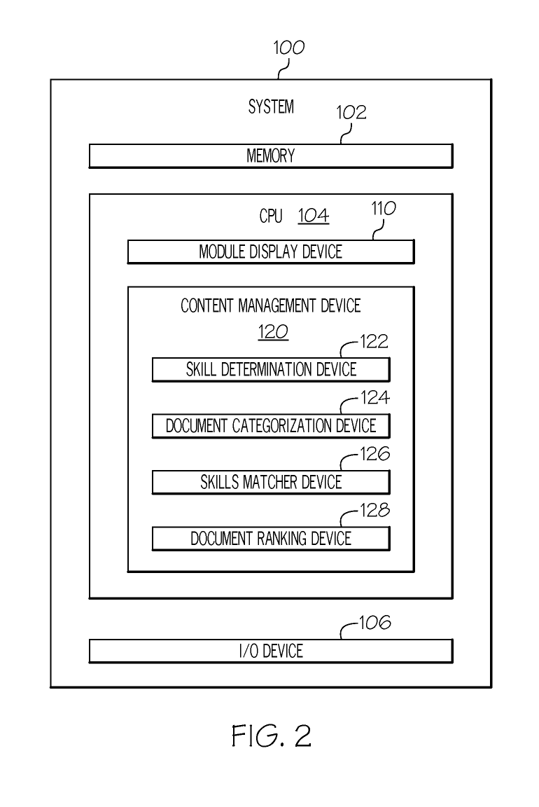

Referring now to FIG. 2, system 100, which provides a collaborator recommendation module, is now described. System 100 may reside on one or more networks 1. System 100 may comprise a memory 102, a central processing unit (“CPU”) 104, and an input and output (“I/O”) device 106.

Memory 102 may store computer-readable instructions that may instruct system 100 to perform certain processes. As discussed above, memory 102 may comprise, for example, RAM, ROM, EPROM, Flash memory, or any suitable combination thereof. In particular, when executed by CPU 104, the computer-readable instructions stored in memory 102 may instruct CPU 104 to operate as one or more devices.

CPU 104 may operate as one or more of a module display device 110 and a content management device 120. Content management device 120 may comprise a skill determination device 122, a document categorization device 124, a skills matcher device 126, and a document ranking device 128.

I/O device 106 may receive data from networks 1, data from other devices connected to system 100, and/or input from a user and provide such information to CPU 104. I/O device 106 may transmit data to networks 1, may transmit data to other devices connected to system 100, and may transmit information to a user (e.g., display the information via a display device). Further, I/O device 106 may implement one or more of wireless and wired communication between system 100 and other devices.

Today, knowledge workers often need to collaborate with other workers, especially when they may not be present in the same location. Typically, a worker may use his network of company “friends” that come to mind or a company's directory listing to find collaborators to work with or for help on certain tasks. However, the worker's network may be limited in this way by the number of people that the worker may retain in his memory, and the company directory may potentially be very large. Thus, the process of finding collaborators to work with may become onerous and time-consuming, costing workers valuable time in order to find suitable collaborators for various skill-driven tasks.

The teachings of the present disclosure may provide a collaborator recommendation module that allows a user to more efficiently and effectively find suitable collaborators to work on a particular task with a high likelihood that the recommended collaborators possess the skills sought by the user. In particular, the teachings of this disclosure enable the organization and recommendation of suitable collaborators by clustering each user's (e.g., each potential collaborator's) content in a central system (e.g., a content management system made available by CA Technologies, see www.ca.com) with skills as categories, assigning a score for each skill based on an overall affinity of a user's content to that skill/category, and building a n-dimensional skills vector for user. Then, when a user looks for a collaborator, the user may select a document (e.g., a document that the user has created or edited), or a set of documents, as a sample of a particular task the user wants to find collaborators for. The system may then process the document or set of documents (e.g., a content group), by clustering the document in the aforementioned categories, searching for matching users (potential collaborators) who have been assigned high scores for the these categories, rank ordering the list of matched users by these scores for these categories, and then presenting the user with the ranked list to select one or more suitable collaborators. Documents may include word processing generated documents, web pages, pdfs, emails, database/store records, software code management or revision stores, wiki entries, stored photograph images and any other types of electronic data that a user would like to store in order to view or otherwise access in the future.

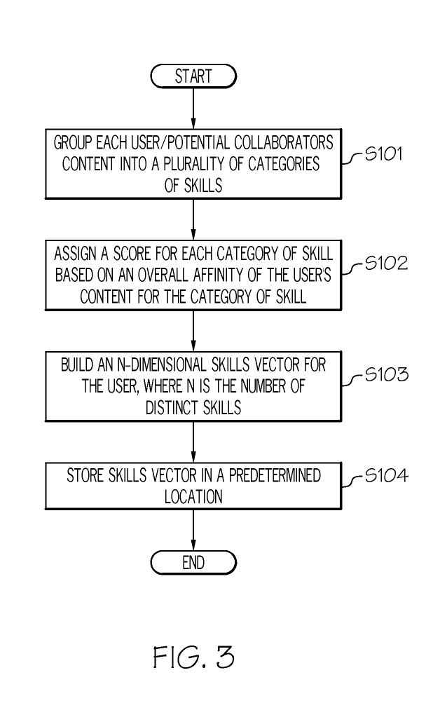

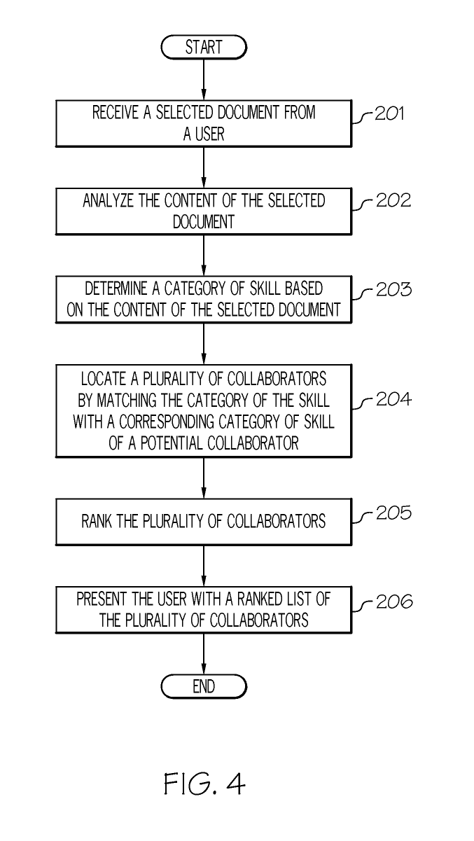

Referring now to FIGS. 3 and 4, processes performed by module display device 110 and content management device 120 are now described.

FIG. 3 illustrates a method of determining and categorizing a plurality of users' (e.g., potential collaborators') skill set. In S101, skill determination device 122 may group each user's content into a plurality of categories of skills. The user's content may include any and all documents that the user has previously created, edited, view, and/or accessed. The plurality of categories of skills may include a number of predetermined, software-defined or user-defined skills, for example, computer language skills (e.g., JAVA, C#, etc.), specific software program skills and/or experience (e.g., Sharepoint, SaleForce, etc.), management skills (e.g., Six Sigma, etc.), finance skills, and any other skills that may be important in potential collaborators. In addition, the categories of skills of potential collaborators may include, for example, skills listed on a resume of the potential collaborator, skills listed in a job application, skills listed in a company questionnaire or survey, or other suitable lists of skills.

In S102, skill determination device 122 may assign a score for each category of skill based on an overall affinity of the user's content for the skill (e.g., how skilled a user is at a particular category of skill, or categories of skills in view of the user's content). The overall affinity of the user's content may be determined by calculating the number of documents of the user's total number of documents that fall into each category of skill, by looking at the number of documents created and/or the number of documents edited that fall into each category of skill, or any other suitable method. For example, the overall affinity may be determined by looking at the number of documents created by the user, and the number of documents edited by the user; a high number of prior creations, followed by a high number of edits, may show high affinity (i.e., high subject matter expertise). Then, in S103, skill determination device 122 may build an n-dimensional skills vector for the user, where n is the number of distinct skills. The n-dimensional skills vector would include a list of skills and the corresponding score for each skill for the user.

Then, in S104, skill determination device 122 may store the skills vector for each user (potential collaborator) in a predetermined location (e.g., memory 102, and any other suitable location). After the skills vector is stored, the process terminates.

FIG. 4 depicts a method of presenting a list of potential collaborators to a user based the category of skills needed for a selection of documents received from the user. In S201, module display device 110 receives a selected document from the user. For example, module display device 110 may display a list of documents the user is working on, request that the user select a document, or a set of documents, from the list of documents, and receive a selection of a document or set of documents. Next, document categorization device 122 analyzes the content of the selected document or set of documents (S202), and then determines a category of skill, or categories of skills, based on the content of the selected document (S203). In particular, document categorization device 122 may analyze the document or set of documents to determine what categories of skills may be necessary and/or useful in view of the content of the document(s) (i.e., clustering the content of the selected document into a plurality of skill axes). These categories of skills may correspond to the plurality of categories of skills of a user's (potential collaborator's) skills vector, as discussed above. Moreover, these categories of skills may include the plurality of categories of skills as discussed above with regard to FIG. 3. For example, if a document is coded using JAVA, document categorization device 122 may determine that a category of skill necessary and/or useful for a collaborator for this project is a person who has knowledge of JAVA (e.g., a high score in JAVA skill in the person's skills vector).

Next, in S204, skills matcher device 126 may locate a plurality of collaborators by matching the category of skill, or categories of skills, necessary and/or useful based on the content of the document(s) with a corresponding category of skill, or corresponding categories of skills, of a potential collaborator. Then, in S205, document ranking device 128 may rank the plurality of collaborators based on a predetermined score for the corresponding category of skill. In particular, document ranking device 128 may access the scores assigned for each category of skill of each user (potential collaborator) based on the overall affinity of the user's content for that skill (as discussed above with regard to FIG. 3), and rank the determined list of collaborators by these scores in each category of skill that matches the categories of skills necessary and/or used based on the content of the document(s). In addition, the ranking of the list of collaborators may also include consideration of, for example, availability of the collaborator, proximity, the primary language of the collaborator, and other suitable factors. If a number of categories of skills are being assessed, skills matcher device 126 may use predetermined weighting methods for each category of skill to determine the rank of the list of collaborators.

Then, in S206, I/O device 106 may present the user with a ranked list of the plurality of collaborators. For example, I/O device 106 may present the user with a tab or selection button that, when pressed by the user, may present the ranked list of the plurality of collaborators. After presenting the ranked list of collaborators to the user, the user may select one or more collaborators, and the process may terminate.

The block diagrams and flowcharts in FIGS. 1-4 illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method, comprising:
receiving a selected document from a user;
analyzing content of the selected document;
determining a category of skill based on the content of the selected document;
locating a plurality of collaborators by matching the category of skill with a corresponding category of skill of a potential collaborator selected from a plurality of potential collaborators;
ranking the plurality of collaborators on the corresponding category of skill; and
presenting the user with a ranked list of the plurality of collaborators based on the ranking of the plurality of collaborators.

2. The method of claim 1, wherein a plurality of potential collaborators is determined by:
determining a plurality of categories of skills for each potential collaborator of the plurality of potential collaborators based on user content of each potential collaborator;
assigning a score for each category of skill for each potential collaborator based on an overall affinity of the potential collaborator's content for the category of skill; and
storing the score for each category of skill for each potential collaborator in a predetermined location.

3. The method of claim 2, wherein the user content of each potential collaborator comprises an entire body of documents created or edited by the potential collaborator.

4. The method of claim 3, wherein the overall affinity of the potential collaborator's content for the category of skill is determined by the number of documents of the entire body of documents created or edited by the potential collaborator that correspond to the category of skill.

5. The method of claim 2, wherein
the corresponding category of skill of each collaborator comprises a category of skill of the plurality of categories of skills for each potential collaborator that matches the determined category of skill based on the content of the selected document; and
a predetermined score on the corresponding category of skill of each collaborator used for ranking the plurality of collaborators comprises the score for a category of skill for each potential collaborator based on the overall affinity of the potential collaborator's content for the category of skill.

6. The method of claim 1, wherein determining the category of skill comprises clustering the content of the selected document into a plurality of skill axes.

7. The method of claim 1, wherein receiving a selected document from the user comprises:
presenting a list of documents to the user; and
receiving a selection of a document from the user.

8. A system comprising:
a receiving device configured to receive a selected document from a user;
an analyzing device configured to analyze content of the selected document;
a determining device configured to determine a category of skill based on the content of the selected document;
a locating device configured to locate a plurality of collaborators by matching the category of skill with a corresponding category of skill of a potential collaborator selected from a plurality of potential collaborators;
a ranking device configured to rank the plurality of collaborators on the corresponding category of skill; and
a presenting device configured to present the user with a ranked list of the plurality of collaborators based on the ranking of the plurality of collaborators.

9. The system of claim 8, wherein a plurality of potential collaborators is determined by:
the determining device configured to determine a plurality of categories of skills for each potential collaborator of the plurality of potential collaborators based on user content of each potential collaborator;
an assigning device configured to assign a score for each category of skill for each potential collaborator based on an overall affinity of the potential collaborator's content for the category of skill; and
a storing device configured to store the score for each category of skill for each potential collaborator in a predetermined location.

10. The system of claim 9, wherein the user content of each potential collaborator comprises an entire body of documents created or edited by the potential collaborator.

11. The system of claim 10, wherein the overall affinity of the potential collaborator's content for the category of skill is determined by the number of documents of the entire body of documents created or edited by the potential collaborator that correspond to the category of skill.

12. The system of claim 9, wherein
the corresponding category of skill of each collaborator comprises a category of skill of the plurality of categories of skills for each potential collaborator that matches the determined category of skill based on the content of the selected document; and
a predetermined score on the corresponding category of skill of each collaborator used for ranking the plurality of collaborators comprises the score for a category of skill for each potential collaborator based on the overall affinity of the potential collaborator's content for the category of skill.

13. The system of claim 8, wherein the determining device is further configured to cluster the content of the selected document into a plurality of skill axes.

14. The system of claim 8, wherein the receiving device is further configured to:
present a list of documents to the user; and
receive a selection of a document from the user.

15. A computer program product comprising:
a computer-readable storage medium having computer-readable program code embodied therewith, the computer-readable program code comprising:
computer readable program code configured to receive a selected document from a user;
computer readable program code configured to analyze content of the selected document;
computer readable program code configured to determine a category of skill based on the content of the selected document;
computer readable program code configured to locate a plurality of collaborators by matching the category of skill with a corresponding category of skill of a potential collaborator selected from a plurality of potential collaborators;
computer readable program code configured to rank the plurality of collaborators on the corresponding category of skill; and
computer readable program code configured to present the user with a ranked list of the plurality of collaborators based on the ranking of the plurality of collaborators.

16. The computer program product of claim 15, wherein a plurality of potential collaborators is determined by:
computer readable program code configured to determine a plurality of categories of skills for each potential collaborator of the plurality of potential collaborators based on user content of each potential collaborator;
computer readable program code configured to assign a score for each category of skill for each potential collaborator based on an overall affinity of the potential collaborator's content for the category of skill; and
computer readable program code configured to store the score for each category of skill for each potential collaborator in a predetermined location.

17. The computer program product of claim 16, wherein the user content of each potential collaborator comprises an entire body of documents created or edited by the potential collaborator.

18. The computer program product of claim 17, wherein the overall affinity of the potential collaborator's content for the category of skill is determined by the number of documents of the entire body of documents created or edited by the potential collaborator that correspond to the category of skill.

19. The computer program product of claim 16, wherein
the corresponding category of skill of each collaborator comprises a category of skill of the plurality of categories of skills for each potential collaborator that matches the determined category of skill based on the content of the selected document; and
a predetermined score on the corresponding category of skill of each collaborator used for ranking the plurality of collaborators comprises the score for a category of skill for each potential collaborator based on the overall affinity of the potential collaborator's content for the category of skill.

20. The computer program product of claim 15, wherein the computer readable program code is further configured to cluster the content of the selected document into a plurality of skill axes.

21. The computer program product of claim 15, wherein the computer readable program code is further configured to:
present a list of documents to the user; and
receive a selection of a document from the user.
